(19) United States
(12) Patent Application Publication
(10) Pub. No.: US 2026/0087915 A1
(43) Pub. Date: Mar. 26, 2026

(54) OUTPUT SYSTEM, OUTPUT DEVICE, AND OUTPUT METHOD

(71) Applicant: KYOCERA Corporation, Kyoto (JP)

(72) Inventors: Toshikazu KANAOKA, Yokohama-shi (JP); Jacqueline URAKAMI, Tokyo (JP); Akito MORIWAKI, Yokohama-shi (JP)

(73) Assignee: KYOCERA Corporation, Kyoto (JP)

(21) Appl. No.: 19/338,977

(22) Filed: Sep. 24, 2025

(30) Foreign Application Priority Data
Sep. 25, 2024 (JP) 2024-166516

(51) Int. Cl. G08B 7/06; G10L 25/51

(52) U.S. Cl. CPC G08B 7/06; G10L 25/51

(57) ABSTRACT

In an embodiment of the present disclosure, an output system includes an acquisition unit and an output unit. The acquisition unit acquires a sound including an utterance. The output unit outputs a visual, auditory, or tactile stimulus. The output unit outputs, when the utterance is being made, the stimulus based on a length of beat-to-beat interval included in the utterance.

### CROSS REFERENCES TO RELATED APPLICATIONS

The present disclosure contains subject matter related to Japanese Patent Application No. 2024-166516 filed in the Japan Patent Office on Sep. 25, 2024, the entire contents of which are incorporated herein by reference.

### BACKGROUND

### 1. Field

The present disclosure relates to an output system, an output device, and an output method.

### 2. Description of the Related Art

In the related art, an earphone equipped with a hear-through mode is disclosed, where the here-through mode provides a user with acquired ambient sound. However, the user may miss the ambient sound. Japanese Unexamined Patent Application Publication (Translation of PCT Application) No. 2015-537466 is an example of the related art.

### SUMMARY

In an embodiment of the present disclosure, an output system includes an acquisition unit and an output unit. The acquisition unit acquires a sound including an utterance. The output unit outputs a visual, auditory, or tactile stimulus. The output unit outputs, when the utterance is being made, the stimulus based on a length of beat-to-beat interval included in the utterance.

In an embodiment of the present disclosure, an output device includes an acquisition unit and an output unit. The acquisition unit acquires a sound including an utterance. The output unit outputs a visual, auditory, or tactile stimulus. The output unit outputs, when the utterance is being made, the stimulus based on a length of beat-to-beat interval included in the utterance.

In an embodiment of the present disclosure, an output method includes: acquiring a sound including an utterance with an acquisition unit; and outputting a visual, auditory, or tactile stimulus with an output unit. The output unit outputs, when the utterance is being made, the stimulus based on a length of beat-to-beat interval included in the utterance.

### BRIEF DESCRIPTION OF THE DRAWINGS

FIG. 1 is a diagram for illustrating a schematic configuration of an output system;

FIG. 2 is a view for illustrating parameters of a stimulus when the stimulus is vibration;

FIGS. 3A to 3D illustrate cases where chunks are outputted at an output interval obtained by multiplying a set mora length;

FIGS. 4A to 4C illustrate the relationship between a sound reproduced by a first output unit and output of the chunks by a second output unit;

FIG. 5 is a flowchart for illustrating a processing flow of an output device;

FIGS. 6A to 6D illustrate that, in an output system of Example 2, a second output unit outputs chunks based on an utterance envelope of a sound signal; and

FIGS. 7A to 7D illustrate that, in an output system of Example 3, a second output unit outputs chunks based on an utterance envelope of a sound signal.

### DESCRIPTION OF THE PREFERRED EMBODIMENTS

Embodiments of the present disclosure will be described below with reference to the drawings. In each of the drawings, the same reference numerals indicate components having the same or equivalent functions. Note that the configurations, numerical values, processing flows, functions, and elements described in the following embodiments are merely examples, and variations and modifications thereof can be made freely. The scope of the present invention is not intended to be limited to the following description.

### Example 1

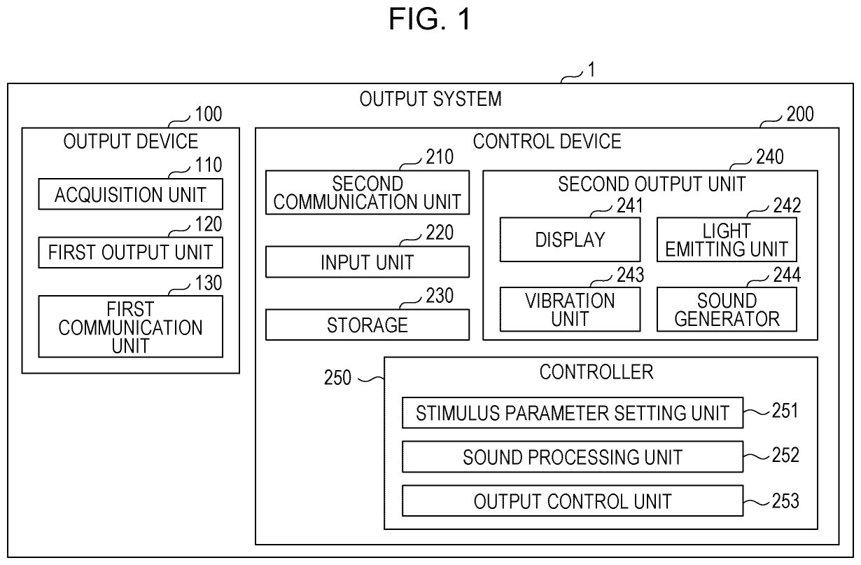

FIG. 1 is a diagram for illustrating a schematic configuration of an output system 1 in Example 1.

The output system 1 includes an output device 100 and a control device 200. The output device 100 and the control device 200 may be separate devices or a single device.

The output device 100 outputs a sound to a user. The output device 100 is, for example, an earphone. Note that the output device 100 is not limited to an earphone and may be a headphone, a headset, a speaker, a smartphone, or the like.

A schematic configuration of the output device 100 will be described below. The output device 100 includes an acquisition unit 110, a first output unit 120, and a first communication unit 130.

The acquisition unit 110 is, for example, a microphone. The acquisition unit 110 acquires ambient sound and converts the acquired ambient sound into a sound signal. The ambient sound includes utterance(s). An utterance is a sound produced when a language is uttered as the sound. The utterance includes an utterance uttered by the user, an utterance uttered by a person around the user, and an utterance uttered by a sound source (a speaker or the like) around the user.

The acquisition unit 110 may be provided outside the output device 100 and can communicate with either or both of the output device 100 and the control device 200 by wire or radio. The acquisition unit 110 may be included in the control device 200.

The first output unit 120 is, for example, a speaker. The first output unit 120 outputs a sound to the user. When the output device 100 is a so-called canal-type earphone, a so-called here-through mode may function in which the sound acquired by the acquisition unit 110 is outputted, as it is, from the first output unit 120 in real time. When the output device 100 is a so-called open-ear earphone and the user can directly hear the ambient sound, the first output unit 120 is not necessarily included in the output device 100.

The first communication unit 130 is, for example, a communication module; the first communication unit 130 is connected to the control device 200 to perform communication with the control device 200. The communication module corresponds to any communication standard. The communication standard is, for example, a wired communication standard or a short-range wireless communication standard such as Bluetooth (registered trademark), infrared rays, and NFC.

The output device 100 can transmit the sound signal of the sound acquired by the acquisition unit 110 to the control device 200 via the first communication unit 130.

A schematic configuration of the control device 200 will be described.

The control device 200 may be a terminal capable of controlling the output device 100; examples of the terminal include a smartphone, a smartwatch, and smart glasses.

The control device 200 includes a second communication unit 210, an input unit 220, a second output unit 240, a storage 230, and a controller 250. One or more configurations included in the control device 200 may be included in the output device 100. One or more configurations included in the control device 200 may be provided outside the control device 200 and the one or more configurations can communicate with either or both of the control device 200 and the output device 100 by wire or radio. For example, the storage 230 may be disposed in a remote server that can communicate with the control device 200 via a network system or the like. For example, the second output unit 240 may be a device that can communicate with either or both of the output device 100 and the control device 200 via a network system or the like.

The second communication unit 210 is, for example, a communication module connected to the first communication unit 130 to perform communication between the output device 100 and the control device 200. The communication module may correspond to the same communication standard as the first communication unit 130. The connection between the second communication unit 210 and the first communication unit 130 enables communication between the output device 100 and the control device 200. The second communication unit 210 can receive the sound signal of the sound transmitted from the output device 100 via the first communication unit 130.

The input unit 220 includes an input interface that can accept input from the user. The input unit 220 may include one or more buttons and/or a touch panel. The input unit 220 may be used by the user to select a process to be executed by the output device 100.

The second output unit 240 outputs a stimulus to the user. The second output unit 240 may output the stimulus when the acquisition unit 110 is acquiring an ambient sound. The second output unit 240 may include one or more of a display 241, a light emitting unit 242, a vibration unit 243, and a sound generator 244.

The display 241 is, for example, a display disposed on the surface of the control device 200. The display 241 displays an image or video to output a visual stimulus to the user.

When the input unit 220 is a touch panel display or the like, instead of providing the display 241 in the control device 200, the input unit 220 of the control device 200 may be used as the display 241.

The light emitting unit 242 may be, for example, an LED (light emitting diode) disposed on the surface of the control device 200. The light emitting unit 242 emits light to output a visual stimulus to the user.

The vibration unit 243 includes a vibration element such as a piezoelectric element. The vibration unit 243 vibrates to output a tactile stimulus to the user.

The sound generator 244 is, for example, a speaker. The sound generator 244 generates a sound to output an auditory stimulus to the user. Instead of providing the sound generator 244 in the control device 200, the first output unit 120 of the output device 100 may be used as the sound generator 244.

The storage 230 is a storage medium including a ROM (read only memory) or a RAM (random access memory). The storage 230 may store a program to be executed by the output system 1. The program may include a sound processing program to be executed by the output system 1.

The controller 250 includes at least one processor, at least one dedicated circuit, or a combination thereof. The processor may be a general-purpose processor such as a CPU or a GPU, or a dedicated processor specialized for a specific process. The dedicated circuit may be, for example, an FPGA or an ASIC. The controller 250 executes processing related to the operation of the output system 1 while controlling each configuration of the output system 1.

The configurations included in the controller 250 may be composed of hardware, software, or both. Each of the configurations included in the controller 250 may be controlled by the controller 250. The controller 250 can cause the output system 1 to execute various processing in response to the input through the input unit 220 by the user.

The controller 250 includes a stimulus parameter setting unit 251, a sound processing unit 252, and an output control unit 253. One or more configurations included in the controller 250 may be provided outside the controller 250.

The stimulus parameter setting unit 251 calculates and holds parameters to be used when the second output unit 240 outputs the stimulus. The parameters are set by performing, by the user, an input operation on the input unit 220, and may be set as user-specific values.

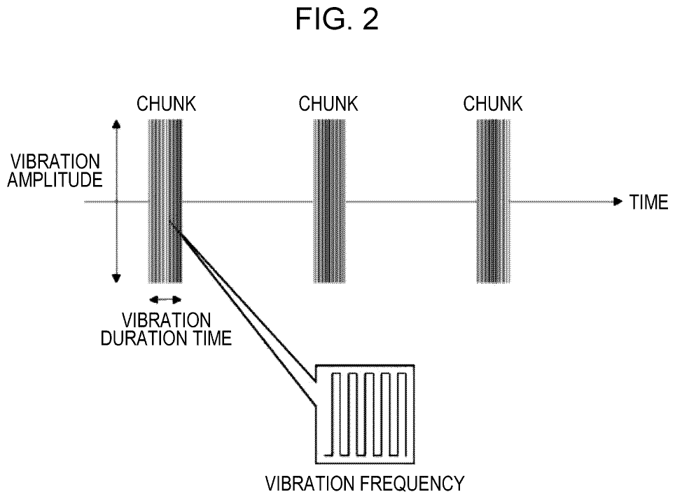

The parameters will be described when the stimulus is a tactile stimulus, i.e., vibration. FIG. 2 is a view for illustrating the parameters of the stimulus when the stimulus is vibration. When the stimulus is vibration, the parameters include vibration frequency, vibration amplitude, and vibration duration time. The vibration frequency is the number of times the vibration is repeated per unit time. The vibration frequency may be, for example, from 150 Hz to 250 Hz. The vibration amplitude indicates the intensity of the vibration. The intensity of the vibration may be an intensity that humans can perceive. The vibration duration time is the length of time during which the output of the vibration continues. The vibration duration time may be, for example, 100 ms or longer.

When the stimulus is a visual stimulus, the parameters include duration time and color. The duration time is the length of time during which the display 241 or the light emitting unit 242 maintains a predetermined display or light emission. The duration time may be, for example, 100 ms or longer.

The color is the color of the visual stimulus (display or light emission) outputted by the display 241 or the light emitting unit 242. The color outputted by the display 241 or the light emitting unit 242 may be a color based on emotion information included in the utterance acquired by the acquisition unit 110. The emotion information indicates the emotion of the person who makes the utterance; the emotion information includes information that indicates negative emotions such as sadness and anger, and positive emotions such as fun, joy, and happiness. The stimulus parameter setting unit 251 may use a known method to estimate the emotion of the person who makes the utterance. For example, if the emotion information of the utterance acquired by the acquisition unit 110 is the positive emotion, the color may be a warm color (for example, red, orange, or yellow). If the emotion information of the utterance acquired by the acquisition unit 110 is the negative emotion, the color may be a cool color (for example, green, blue, or purple).

When the stimulus is an auditory stimulus, the parameters include frequency, sound volume, and duration time. The frequency of the sound is a parameter indicating the pitch of the sound. The frequency may be set based on a basic frequency acquired from an utterance section of the utterance acquired by the acquisition unit 110. The stimulus parameter setting unit 251 may acquire the basic frequency from the utterance section of the utterance using a known method such as an autocorrelation method. The stimulus parameter setting unit 251 may, for example, set the frequency to 2 times the acquired basic frequency. If the utterance acquired by the acquisition unit 110 is an utterance made by a male (basic frequency=from 80 Hz to 200 Hz), the frequency of the sound may be set to from 100 Hz to 400 Hz. If the utterance acquired by the acquisition unit 110 is an utterance made by a female (basic frequency=from 150 Hz to 400 Hz), the frequency of the sound may be set to from 200 Hz to 800 Hz. The sound volume is the magnitude of the sound. The duration time is the length of time during which the sound generator 244 maintains the sound output. The duration time may be, for example, 100 ms or longer.

The stimulus parameter setting unit 251 may prompt the user to perform an input operation to set the value of each parameter. The stimulus parameter setting unit 251 may allow the user to set the value of the parameter for each parameter within a range from a predetermined upper limit value to a predetermined lower limit value. The stimulus parameter setting unit 251 may hold the value of the parameter selected by the user.

The second output unit 240 outputs the stimulus based on the parameters held by the stimulus parameter setting unit 251. In this specification, the stimulus outputted by the second output unit 240 during one duration time may be collectively referred to as a “chunk”.

The sound processing unit 252 processes the sound signal acquired from the control device 200.

The sound processing unit 252 detects an utterance section from the sound signal acquired from the control device 200. The sound processing unit 252 may detect the utterance section by performing voice recognition processing on the sound signal. The utterance section is a section in which the utterance state continues. The utterance section may be a section in which the utterance continues at a predetermined sound volume or higher. If the time during which the utterance is at a sound volume lower than the predetermined sound volume, or during which no utterance is made, is within a predetermined time, it may be considered that the utterance continues. The predetermined time may be, for example, 400 ms. The starting point of the utterance section is also described as “utterance start time point”. The ending point of the utterance section is also described as “utterance end time point”. The sound processing unit 252 may detect a non-utterance section. The non-utterance section is a section in which the utterance is not in the utterance state. The non-utterance section may also be a section in which the sound volume of the utterance is lower than a predetermined sound volume. If the time during which the utterance is at a sound volume lower than the predetermined sound volume, or during which no utterance is made, is equal to or longer than a predetermined time, such a time period may be considered a non-utterance section. The predetermined time may be, for example, 400 ms. The utterance section may be a section between two non-utterance sections.

The utterance section may be a section of an utterance outputted from a single sound source.

The sound processing unit 252 detects, based on the sound signal in the detected utterance section, the number of moras included in a predetermined time (may be referred to as “first time”) in the utterance section. A mora is the length of beat-to-beat interval. The length of beat-to-beat interval may be the length between the timing of the start of a given beat and the timing of the start of the next beat. The length of beat-to-beat interval may be extracted based on the length of the mora included in the utterance. The first time may be a time that is shorter than the utterance section and that is the time taken to utter a plurality of moras. The first time may be preset, and may be the time in which at least two or more moras are generated. The first time may be, for example, 1 second. In the first time, the sound processing unit 252 may detect the number of moras, for example, from text information of the utterance converted from the sound signal using voice recognition.

Instead of detecting the number of moras, the sound processing unit 252 may detect the number of syllables. The length of beat-to-beat interval may include the syllables.

The sound processing unit 252 calculates an average mora length based on the detected number of moras and the time of the utterance section to be detected (the first time). The average mora length is the length of the average time of the moras included in the utterance section. The average mora length may be a value obtained by dividing the number of moras included in the utterance section by the first time. The sound processing unit 252 may hold the calculated average mora length as a set mora length. In this specification, the held average mora length may be referred to as the set mora length. The sound processing unit 252 may calculate the average mora length based on the time taken for the number of moras detected from the sound signal in one utterance section to reach a predetermined number (for example, 2), without depending on a preset predetermined time.

The sound processing unit 252 can calculate the average of the lengths of beat-to-beat interval included in the utterance by calculating the average mora length.

The sound processing unit 252 calculates, based on the set mora length, the output interval at which the second output unit 240 outputs the chunk. The second output unit 240 outputs the chunk a plurality of times for each output interval calculated by the sound processing unit 252.

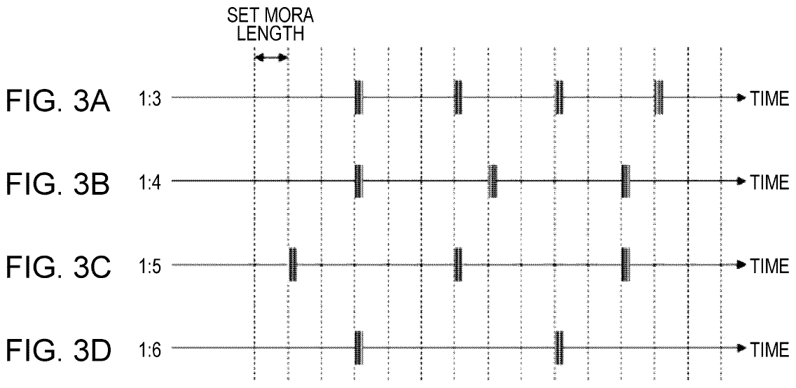

The sound processing unit 252 may calculate an interval obtained by multiplying the set mora length as the output interval. That is, the output interval may be a length obtained by multiplying the length of beat-to-beat interval. The multiplication number may be set by performing, by the user, an input operation on the input unit 220. FIGS. 3A to 3D illustrate cases where the chunks are outputted at an output interval obtained by multiplying the set mora length. In FIGS. 3A to 3D, the set mora length is the length of the interval between the dotted lines. FIG. 3A is a diagram illustrating a case where the chunks are outputted at an output interval obtained by multiplying the set mora length by 3. FIG. 3B is a diagram illustrating a case where the chunks are outputted at an output interval obtained by multiplying the set mora length by 4. FIG. 3C is a diagram illustrating a case where the chunks are outputted at an output interval obtained by multiplying the set mora length by 5. FIG. 3D is a diagram illustrating a case where the chunks are outputted at an output interval obtained by multiplying the set mora length by 6.

The length of the output interval may be longer than the vibration duration time. During the output interval, the length of time during which the chunks are not outputted may be within the range of the predetermined time. The output interval may be set, for example, based on Equation (1) below.

$$300 ms < ( output interval - vibration duration time ) < 800 ms \qquad Equation ( 1 )$$

(output interval−vibration duration time) is the length of time during which the chunks are not outputted, in the output interval.

Table 1 shows the output interval when the duration time is 100 ms. The first row of the table shows the set mora length. The first column of the table shows the multiplication number set by the user. The sound processing unit 252 may calculate the output interval as shown in Table 1, for example. For example, when the set mora length is ⅙s and the multiplication number is 1:3, the sound processing unit 252 may calculate the output interval as 500 ms (⅙s×3). For example, when the set mora length is ⅙s and the multiplication number is 1:6, the sound processing unit 252 may calculate the output interval as ⅙s×6=1000 ms. However, based on Equation (1), 900 ms close to 1000 ms may also be calculated as the output interval.

TABLE 1

| | | Set mora length /s | | | |
|---|---|---|---|---|---|
| | | 1/6 | 1/7 | 1/8 s | 1/9 |
| Multi- | (a) 1:3 | 500 ms | 429 ms | [symbol] →400 ms | [symbol] →400 ms |
| plication | (b) 1:4 | 667 ms | 571 ms | 500 ms | 444 ms |
| number | (c) 1:5 | 833 ms | 714 ms | 625 ms | 556 ms |
| | (d) 1:6 | [symbol] →900 ms | 857 ms | 750 ms | 667 ms |

The output control unit 253 causes the second output unit 240 to output a stimulus (chunks) with the parameters held by the stimulus parameter setting unit 251 based on the output interval calculated by the sound processing unit 252. The output control unit 253 may cause the second output unit 240 to output chunks when the acquisition unit 110 acquires the utterance included in the sound, i.e., when the utterance is being made. The output control unit 253 causes the second output unit 240 to output the stimulus based on the average mora length, i.e., the length of beat-to-beat interval included in the utterance.

The output control unit 253 causes the second output unit 240 to output the chunks based on the utterance section and the non-utterance section detected by the sound processing unit 252. Specifically, the output control unit 253 causes the second output unit 240 to output the chunks in the utterance section at the calculated output interval. When the first output unit 120 outputs the sound acquired by the acquisition unit 110, a slight delay may occur. When such a delay occurs, the output control unit 253 may control the timing of outputting the chunks so that the chunks are outputted at an appropriate output interval in the utterance section. If the non-utterance section of the sound acquired from the output device 100 is a non-utterance section of a length equal to or longer than a predetermined length (e.g., 400 ms), the chunk stimulus outputted by the second output unit 240 may be weakened or the output of the chunks may be stopped. If the non-utterance section of the sound acquired from the output device 100 is a non-utterance section of a length shorter than the predetermined length, the chunks may be continuously outputted to the second output unit 240 at the calculated output interval.

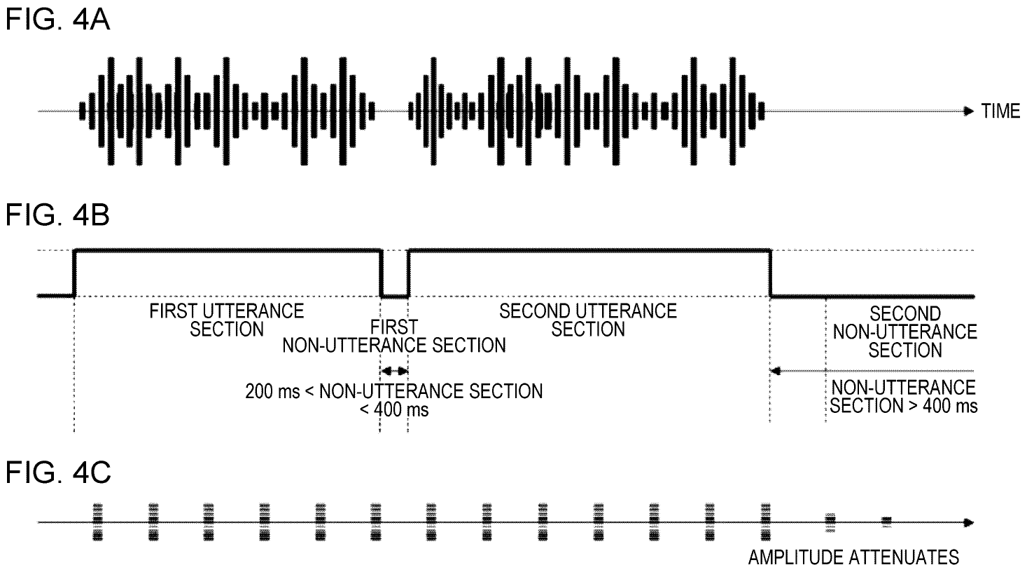

FIGS. 4A to 4C illustrate the relationship between the sound reproduced by the first output unit 120 and the output of the chunks by the second output unit 240. FIG. 4A is a diagram illustrating the sound signal of the sound outputted by the first output unit 120. FIG. 4B is a diagram illustrating whether the sound signal of FIG. 4A is an utterance section or a non-utterance section. FIG. 4C is a diagram illustrating that the second output unit 240 outputs the chunks.

In a first utterance section of FIG. 4B, the output control unit 253 may start outputting the chunks at an output interval calculated from the sound signal in the utterance section within a predetermined time from the utterance start time point. since a first non-utterance section of FIG. 4B is shorter than 400 ms, it may be assumed that the utterance section continues, so that the output of the chunks outputted in the first utterance section is continued. In a second non-utterance section of FIG. 4C, since the non-utterance section continues longer than 400 ms, after the non-utterance section continues for 400 ms, the output control unit 253 may assume that the utterance section is interrupted, so that the magnitude of the chunks outputted by the second output unit 240 is attenuated.

The output control unit 253 may vary the output interval based on the average mora length calculated first by the sound processing unit 252 and the set mora length held in the sound processing unit 252. For example, in a third utterance section following the second non-utterance section, the output control unit 253 may vary the output interval using the average mora lengths calculated from the first utterance section and the second utterance section.

When the stimulus to be outputted is an auditory stimulus, the output control unit 253 may cause the first output unit 120 to output the stimulus. When the first output unit 120 is a stereo earphone composed of two earphones for the right ear and the left ear, the sound including the utterance may be outputted to the speaker of one earphone and the auditory stimulus may be outputted to the speaker of the other earphone.

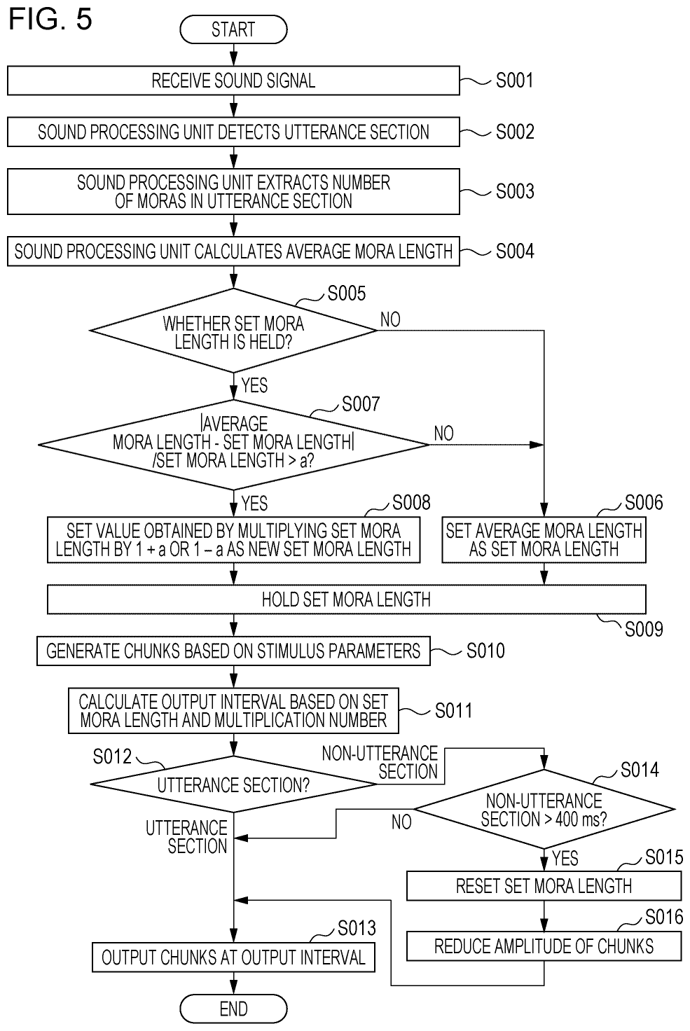

An output method, which is a processing flow of the output system 1, will be described with reference to FIG. 5. FIG. 5 is a flowchart for illustrating a processing flow of the output device 100.

The sound processing unit 252 receives the sound signal of a sound acquired by the acquisition unit 110 (step 1).

The sound processing unit 252 detects an utterance section of the acquired sound signal (step 2).

The sound processing unit 252 extracts the number of moras included in the utterance during the first time in the utterance section (step 3).

The sound processing unit 252 calculates an average mora length based on the number of moras extracted by the sound processing unit 252 and the first time (step 4).

The sound processing unit 252 determines whether a set mora length is held in the sound processing unit 252 (step 5). When no set mora length is held, a new utterance section is started; and when a set mora length is held, an existing utterance section continues.

If no set mora length is held in step 5, the sound processing unit 252 sets the average mora length calculated in step 4 as a set mora length (step 6).

If a set mora length is held in step 5, the sound processing unit 252 determines whether the value calculated by Equation (2) below is larger than a predetermined value a (step 7).

$$\vert average mora length - set mora length \vert / set mora length \qquad Equation ( 2 )$$

The predetermined value a may be, for example, 0.2.

In step 7, if the value calculated by Equation (2) is equal to or smaller than the predetermined value a, the sound processing unit 252 sets the average mora length as a new set mora length (step 6).

In step 7, if the value calculated by Equation (2) is larger than the predetermined value a, the sound processing unit 252 sets a value obtained by multiplying the held set mora length by 1+a or 1−a as a new set mora length so that the average mora length is larger than the set mora length (step 8). The sound processing unit 252 may set a value obtained by multiplying the set mora length by 1+a or 1−a as the set mora length, depending on the relationship between the set mora length and the average mora length, so that the new set mora length is close to the calculated average mora length. By performing the processing of steps 6 to 8, the set mora length can be updated even if the average mora length in the utterance section changes. Thus, the stimulus can be outputted to the user at an appropriate output interval.

The sound processing unit 252 holds the calculated set mora length (step 9).

The stimulus parameter setting unit 251 generates the chunks based on the preset parameters of the stimulus (step 10).

The output interval calculation unit calculates the output interval based on the set mora length held in the sound processing unit 252 and the multiplication number preset by the user (step 11).

The output control unit 253 determines whether the sound acquired by the acquisition unit 110 is an utterance section or a non-utterance section (step 12).

If the sound acquired by the acquisition unit 110 is an utterance section in step 12, the output control unit 253 causes the second output unit 240 to output the chunks at the calculated output interval (step 13). The output control unit 253 can output the stimulus in accordance with the sound heard by the user.

If the sound acquired by the acquisition unit 110 is in a non-utterance section in step 12, an utterance section detection unit determines whether the non-utterance section is longer than a predetermined length (step 14).

If the non-utterance section is shorter than the predetermined length in step 14, the chunks are outputted at the calculated output interval (step 13).

If the non-utterance section is equal to or longer than the predetermined length in step 14, the sound processing unit 252 resets the held set mora length (step 15).

An amplitude of the chunks is reduced (e.g. halved) (step 16), and the second output unit 240 outputs the chunks with the reduced amplitude at the calculated output interval (step 13).

### Example 2

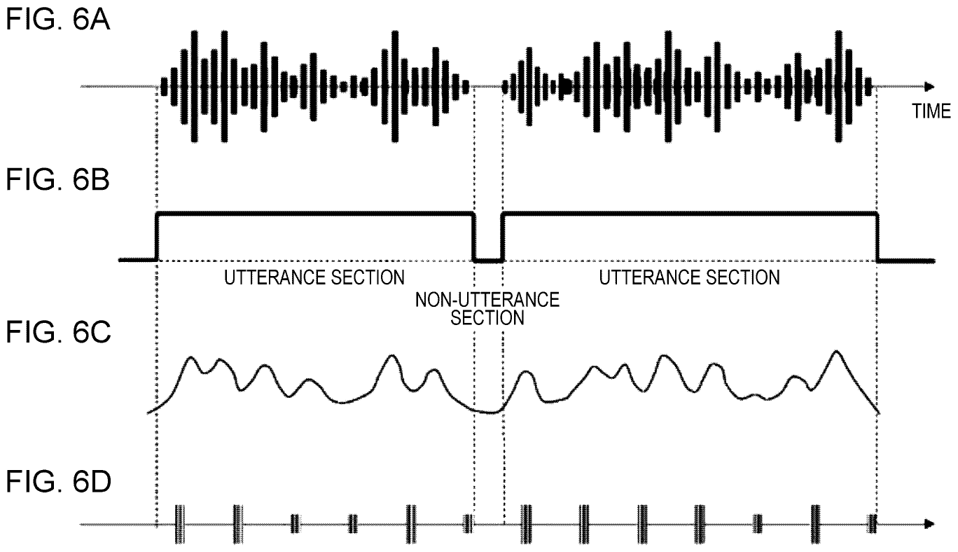

FIGS. 6A to 6D illustrate that, in an output system 1 of Example 2, chunks are outputted based on an utterance envelope of a sound signal. FIG. 6A is a diagram illustrating the sound signal of a sound outputted by the first output unit 120. FIG. 6B is a diagram illustrating whether the sound signal of the sound of FIG. 6A is an utterance section or a non-utterance section. FIG. 6C is a diagram illustrating an utterance envelope calculated by the sound processing unit 252 from the sound signal of FIG. 6A. FIG. 6D is a diagram illustrating that the second output unit 240 outputs chunks with an amplitude or magnitude based on the value of the utterance envelope of FIG. 6C.

In the output system 1 according to Example 2, the sound processing unit 252 in Example 1 calculates an utterance envelope in the utterance section of the acquired sound signal, wherein the utterance envelope indicates the strength of the sound signal. The utterance envelopes are obtained by extracting envelope components of the second power of the acquired sound signal. The envelope may be extracted using a known method such as Hilbert transform, short-time Fourier transform, or the like.

The output control unit 253 detects the value of the utterance envelope corresponding to the sound outputted from the first output unit 120 at the time when the second output unit 240 outputs the chunks. The output control unit 253 may determine, based on the detected value of the utterance envelope, the vibration amplitude or magnitude of the chunks outputted by the second output unit 240. When the value of the utterance envelope is large, the output control unit 253 may increase the vibration amplitude or magnitude of the stimulus outputted by the second output unit 240. When the value of the utterance envelope has changed to a small value, the output control unit 253 may decrease the vibration amplitude or magnitude of the stimulus outputted by the second output unit 240. By varying the vibration amplitude or magnitude of the stimulus outputted by the second output unit 240 based on the value of the utterance envelope, the synchronicity between the sound and the stimulus can be strongly felt, so that attention to the sound can be promoted.

### Example 3

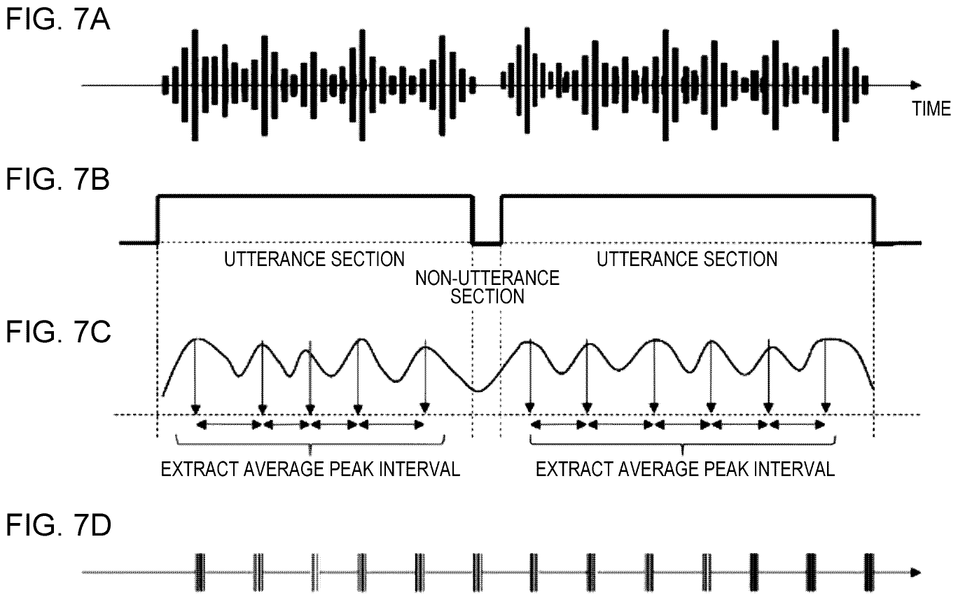

FIGS. 7A to 7D illustrate that, in an output system 1 of Example 3, chunks are outputted based on an utterance envelope of a sound signal. FIG. 7A is a diagram illustrating the sound signal of a sound outputted by the first output unit 120. FIG. 7B is a diagram illustrating whether the sound signal of the sound of FIG. 7A is an utterance section or a non-utterance section. FIG. 7C is a diagram illustrating an utterance envelope calculated by the sound processing unit 252 from the sound signal of FIG. 7A. FIG. 7D is a diagram illustrating that the second output unit 240 outputs chunks at an output interval based on the peak interval of the utterance envelope of FIG. 7C.

In an output system 1 according to Example 3, the sound processing unit 252 in Example 1 calculates an utterance envelope in the utterance section of the acquired sound signal. The utterance envelopes are obtained by extracting envelope components of the second power of the acquired sound signal. The envelope may be detected using a known method such as Hilbert transform, short-time Fourier transform, or the like.

Instead of calculating the average mora length by the sound processing unit 252 according to Example 1, the sound processing unit 252 according to Example 3 may calculate the length of peak-to-peak of the calculated utterance envelope, and calculate the average peak interval by averaging a plurality of the lengths of peak-to-peak in the utterance section. The length of peak-to-peak is the length of beat-to-beat interval. The length of beat-to-beat interval may be extracted based on the accent of the utterance. By calculating the average peak interval with the sound processing unit 252, the average of the lengths of beat-to-beat interval included in the utterance can be calculated.

The sound processing unit 252 may calculate the output interval based on the calculated average peak interval, instead of the average mora length in Example 1.

By calculating the output interval based on the peak-to-peak interval of the utterance envelope, the stimulus based on the accent of the utterance can be outputted.

### Example 4

In an output system 1 according to Example 4, the acquisition unit 110 may be included in the control device 200. The acquisition unit 110 may acquire the sound received by the control device 200 via a communication line. In such a case, the acquisition unit 110 may be composed of software as a function of the controller 250. For example, if the output device 100 is a smartphone, the acquisition unit 110 may acquire the sound received from another device via the communication line. The other device may be a device from which another person makes a call, or a server that provides content such as video, voice and/or the like.

The sound acquired by the acquisition unit 110 may be transmitted from the control device 200 to the output device 100 via the first communication unit 130 and the second communication unit 210. The output device 100 may output the sound transmitted from the control device 200 from the first output unit 120.

### Example 5

In an output system 1 according to Example 5, the acquisition unit 110 may be configured to acquire the sound outputted from the first output unit 120. The control device 200 may output a stimulus based on the sound outputted from the first output unit 120.

The foregoing description of the embodiments has been presented for the purposes of illustration and description. It is not intended to be exhaustive or to limit the disclosure to the precise forms disclosed. Accordingly, many modifications and variations are possible in light of the above teachings. For example, as would be apparent to one skilled in the art, all or part of the described devices and systems may be functionally or physically dispersed or integrated. Furthermore, it is to be understood that the features of the various embodiments described herein may be combined with each other to form other embodiments that are not explicitly described. Such modifications, variations, and combinations are intended to be included within the scope of the appended claims.

What is claimed is:

1. An output system comprising:
a microphone configured to acquire sound including an utterance; and
an output unit configured to output a visual, auditory, or tactile stimulus;
wherein the output unit is configured to output the stimulus, when the utterance is made, based on a length of a beat-to-beat interval included in the utterance.

2. The output system according to claim 1, wherein the output unit is configured to output the stimulus, when the microphone is acquiring sound.

3. The output system according to claim 1, wherein the beat-to-beat interval is a mora included in the utterance.

4. The output system according to claim 3, wherein the output unit is configured to output the stimulus at a first output interval based on an average length of a plurality of the moras included in the utterance.

5. The output system according to claim 4, wherein the first output interval is a length obtained by multiplying the average length of the mora by a natural number.

6. The output system according to claim 1, wherein the output unit is configured to output the stimulus in accordance with the sound.

7. The output system according to claim 1, wherein the beat-to-beat interval is a peak interval of a speech envelope included in the utterance.

8. The output system according to claim 7, wherein the output unit is configured to output the stimulus at a second output interval based on an average length of a plurality of the peak intervals included in the utterance.

9. The output system according to claim 1, wherein the output unit is configured to output the stimulus based on a length of a beat-to-beat interval included in an utterance between two sections of the sound having a volume lower than a specific volume.

10. The output system according to claim 1, wherein the output unit is configured to output the stimulus based on a length of a beat-to-beat interval included in the utterance, and the utterance is output from a single sound source included in the sound.

11. An output apparatus comprising:
a microphone configured to acquire sound including an utterance; and
an output unit configured to output visual, auditory, or tactile stimulus;
wherein the output unit is configured to output the stimulus, when the utterance is made, based on a length of a beat-to-beat interval included in the utterance.

12. An output method comprising:
acquiring, by a microphone, sound including an utterance;
determining a length of a beat-to-beat interval included in the utterance; and
outputting, by an output unit, visual, auditory, or tactile stimulus based on the determined length of the beat-to-beat interval when the utterance is made.
